(19) United States
(12) Patent Application Publication
(10) Pub. No.: US 2024/0261817 A1
(43) Pub. Date: Aug. 8, 2024

(54) MECHANICAL PAINT APPLICATOR ASSEMBLY

(71) Applicant: Kristi Stanwick, Eden Valley, MN (US)

(72) Inventor: Kristi Stanwick, Eden Valley, MN (US)

(21) Appl. No.: 18/106,827

(22) Filed: Feb. 7, 2023

(51) Int. Cl. B05C 17/02

(52) U.S. Cl. CPC B05C 17/0227; B05C 17/0205; B05C 17/0245

(57) ABSTRACT

A mechanical paint applicator assembly for applying paint to a plurality of surfaces of a vertical support of a deck includes a handle assembly. A head is removably couplable to the handle assembly. A plurality of paint rollers is coupled to the head. Each paint roller of the plurality of paint rollers is aligned on an adjustable rotational axis and is independently rotatable relative to each other. An actuator is coupled to the handle assembly and is mechanically couplable with the head. The actuator is actuated to position the paint rollers from a first position wherein the paint rollers are in alignment with each other to a second position wherein the paint rollers are angled with respect to each other.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to painting tools and more particularly pertains to a new painting tool for simultaneously applying paint to a plurality of adjacent surfaces that are non-planar with respect to each other.

### (2) Description of Related Art Including Information Disclosed Under 37 CFR 1.97 and 1.98

The prior art relates to painting tools and includes a variety of painting tools comprising a plurality of paint roller assemblies. However, these devices do not allow for painting adjacent, non-co-planar surfaces simultaneously while also allowing for adjustability to paint adjacently positioned co-planar surfaces.

### BRIEF SUMMARY OF THE INVENTION

An embodiment of the disclosure meets the needs presented above by generally comprising a handle assembly. A head is removably couplable to the handle assembly. A plurality of paint rollers is coupled to the head. Each paint roller of the plurality of paint rollers is aligned on an adjustable rotational axis and is independently rotatable relative to each other. An actuator is coupled to the handle assembly and is mechanically couplable with the head. The actuator is actuated to position the paint rollers from a first position wherein the paint rollers are in alignment with each other to a second position wherein the paint rollers are angled with respect to each other.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric view of a mechanical paint applicator assembly according to an embodiment of the disclosure.

FIG. 2 is a detail isometric view of an embodiment of the disclosure.

FIG. 3 is a side view of an embodiment of the disclosure.

FIG. 4 is a top view of an embodiment of the disclosure.

FIG. 5 is a bottom view of an embodiment of the disclosure.

FIG. 6a is a detail view of an embodiment of the disclosure taken from Magnified Circle 6 of FIG. 3.

FIG. 6b is a detail view of an embodiment of the disclosure taken from Magnified Circle 6 of FIG. 3.

FIG. 7 is a cross-sectional view of an embodiment of the disclosure taken along Line 7-7 of FIG. 4.

FIG. 8 is a cross-sectional view of an embodiment of the disclosure taken along Line 8-8 of FIG. 5.

FIG. 9 is a sectional view of an embodiment of the disclosure.

FIG. 10 is a sectional view of an embodiment of the disclosure.

FIG. 11 is a sectional view of an embodiment of the disclosure.

FIG. 12 is an in-use view of an embodiment of the disclosure.

### DETAILED DESCRIPTION OF THE INVENTION

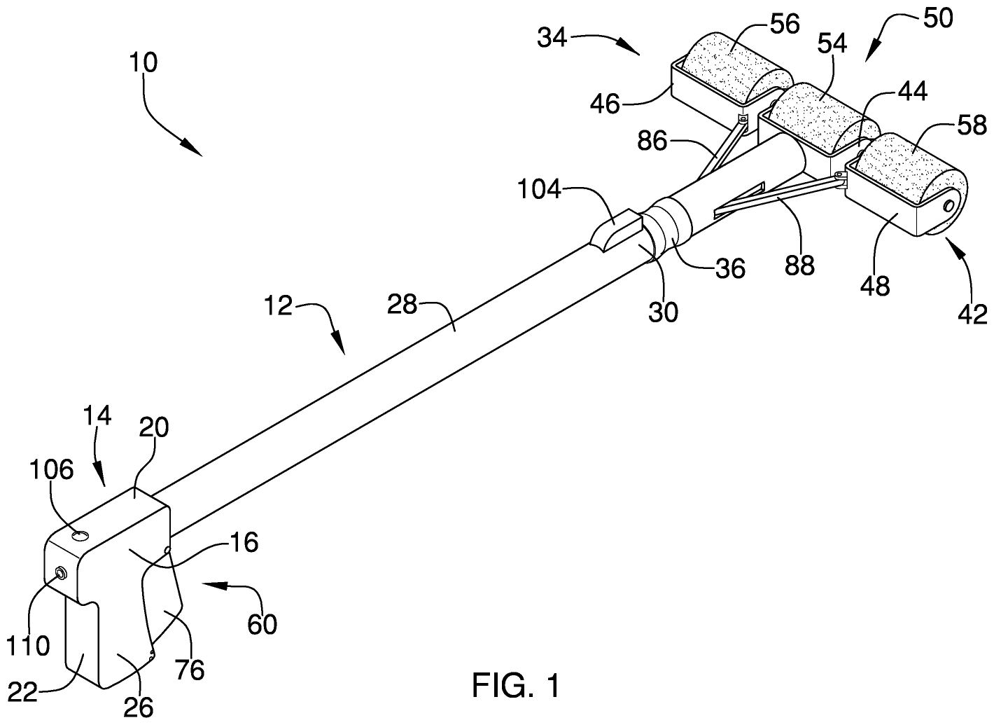

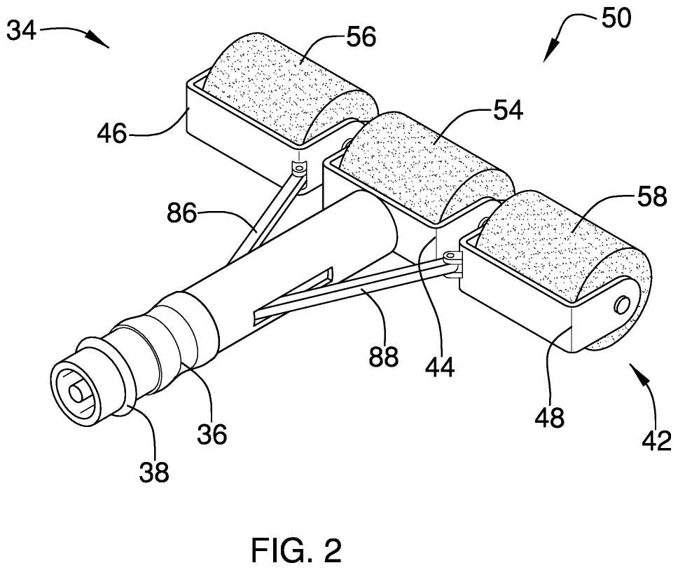

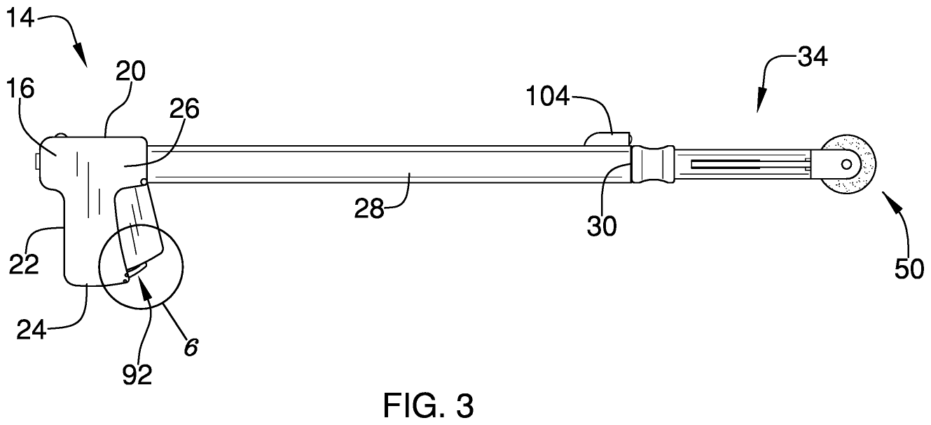

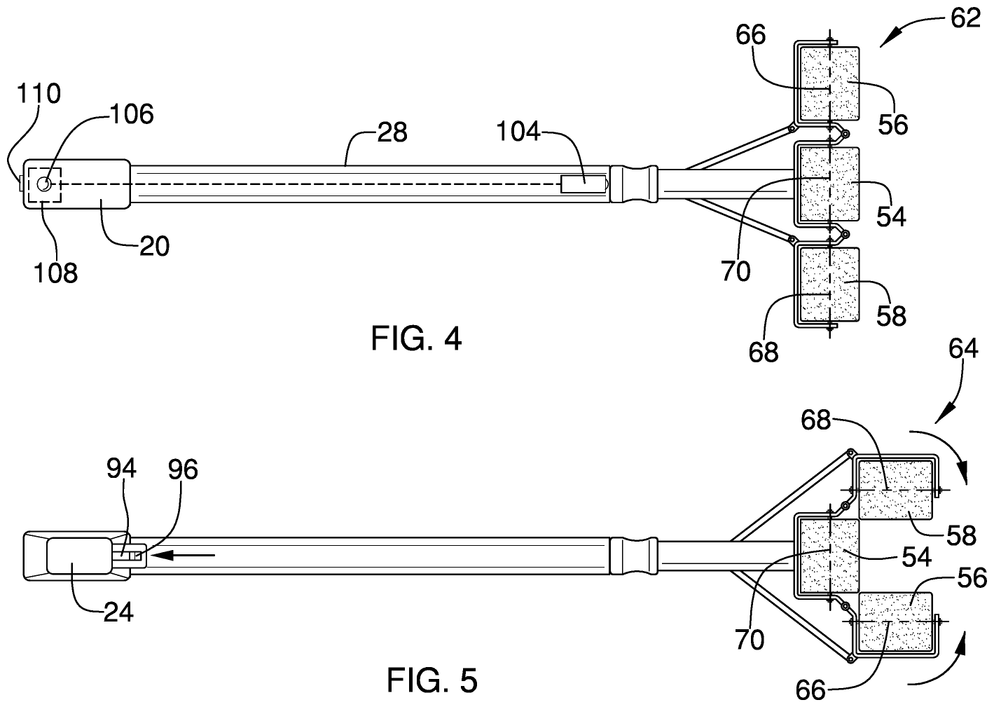

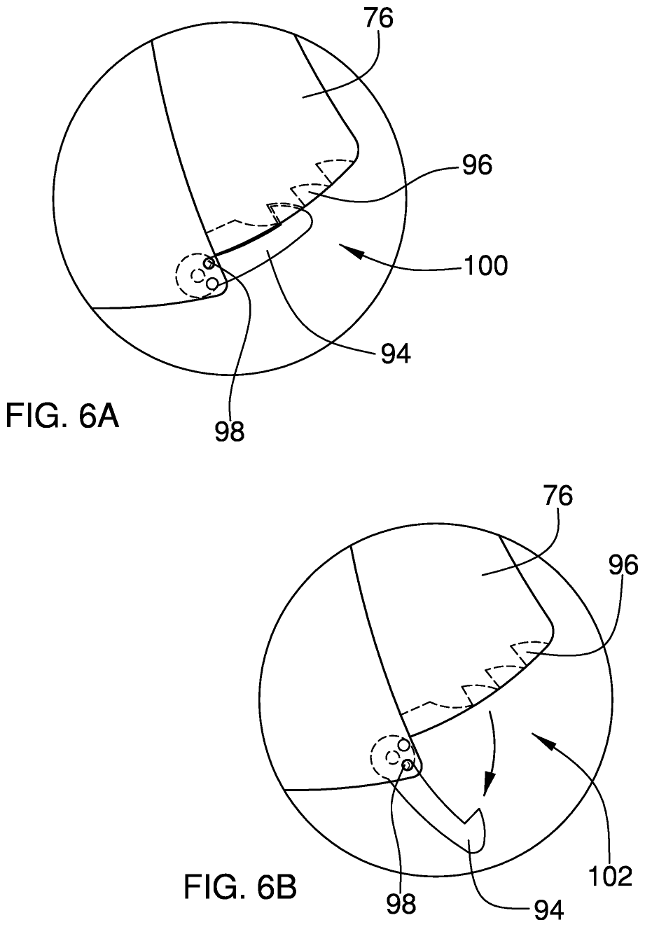

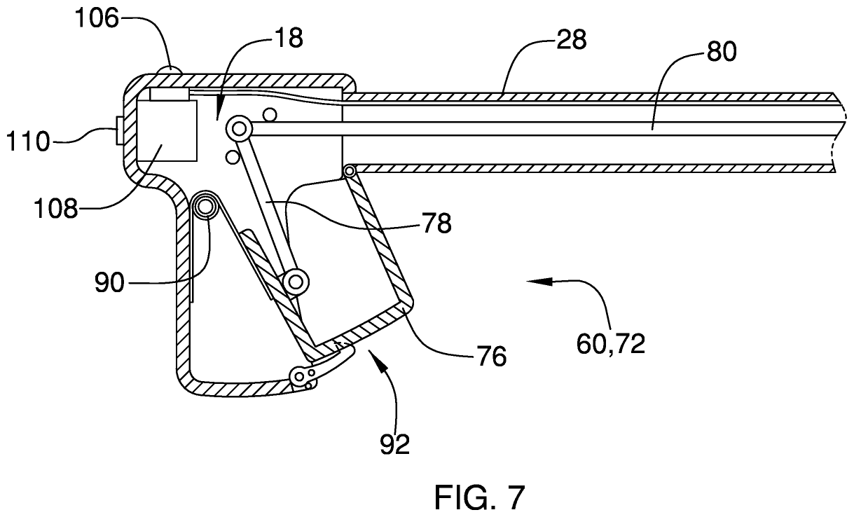

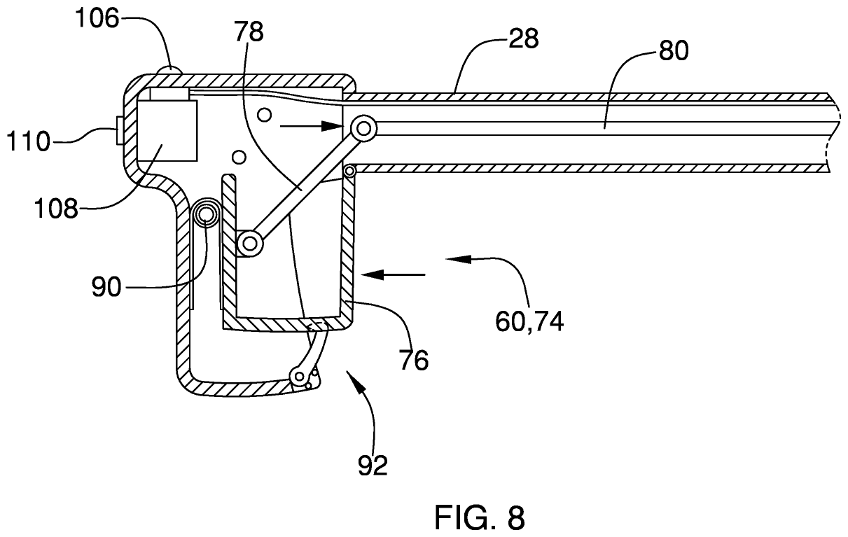

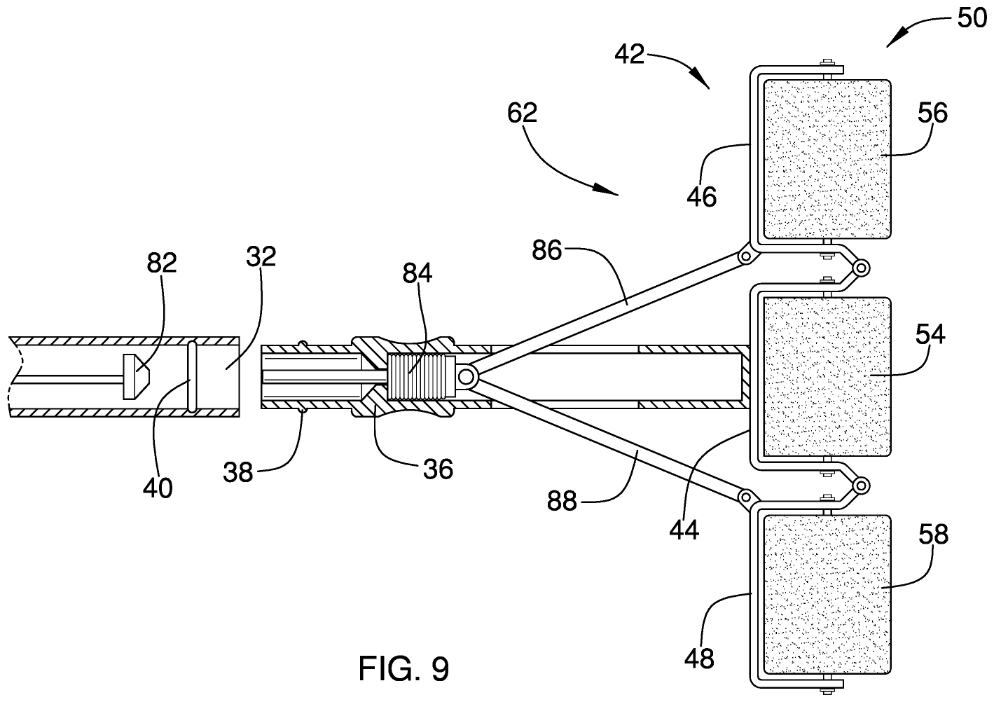

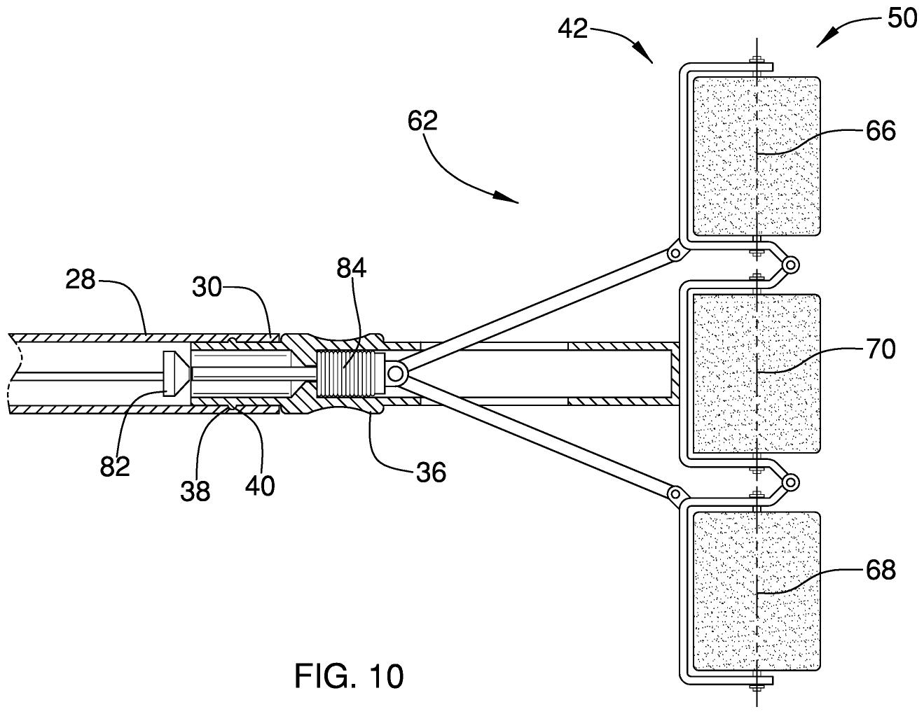

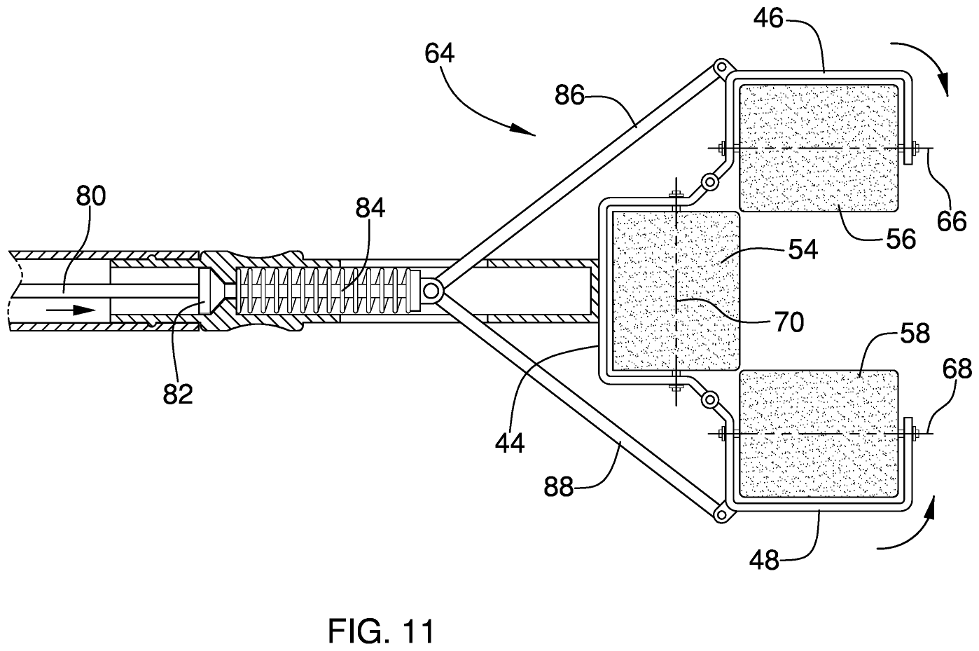

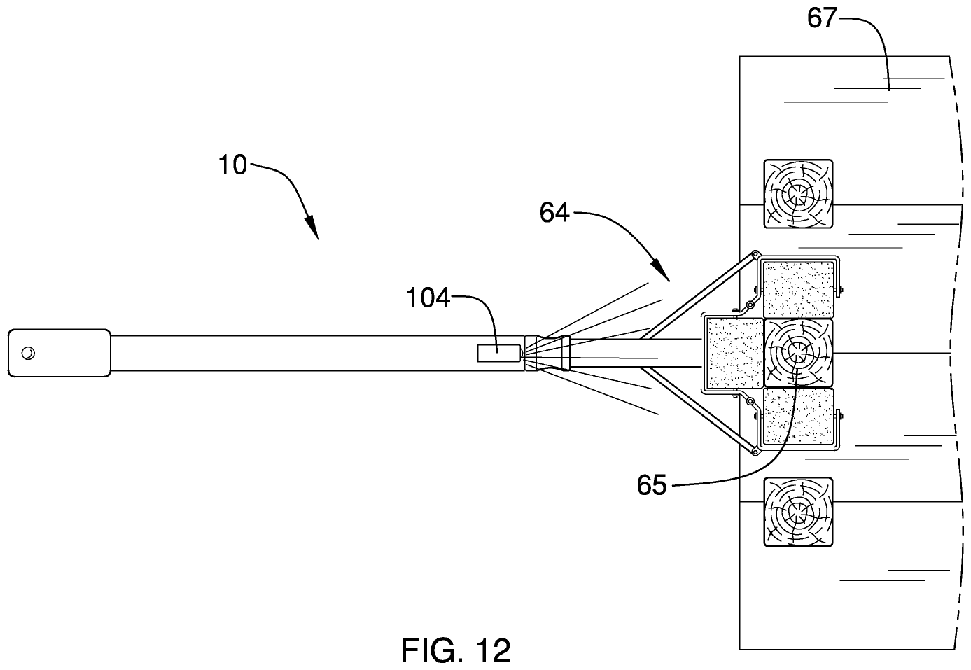

With reference now to the drawings, and in particular to FIGS. 1 through 12 thereof, a new painting tool embodying the principles and concepts of an embodiment of the disclosure and generally designated by the reference numeral 10 will be described.

As best illustrated in FIGS. 1 through 12, the mechanical paint applicator assembly 10 generally comprises a handle assembly 12 including a handgrip 14. The handgrip 14 includes an exterior wall 16 and encloses an interior space 18. The exterior wall 16 includes a top wall 20, a back wall 22, a bottom wall 24, and a pair of side walls 26. Each side wall 26 of the pair of side walls 26 are positioned perpendicular relative to the top 20 and bottom 24 walls. An elongated member 28 is coupled to and extends outwardly from the handgrip 14. An end 30 of the elongated member 28 has an opening 32 therein. The elongated member 28 may comprise a tubular shape.

A head 34 is removably couplable to the handle assembly 12. The head 34 includes an insert 36 being removably insertable within the opening 32 of the elongated member 28. The insert 36 may include a ring 38 being removably positioned within an internal slot 40 of the elongated member 28, wherein the insert 36 may be releasably fastened to the elongated member 28. A receiving bracket 42 is coupled to the insert 36. The receiving bracket 42 includes a central receiver 44, a first lateral receiver 46, and a second lateral receiver 48. The central receiver 44 is static relative to the first 46 and second 48 lateral receivers. The first lateral receiver 46 is pivotally coupled to a first end of the central receiver 44 and the second lateral receiver 48 is pivotally coupled to a second end of the central receiver 44, wherein the first 46 and second 48 lateral receivers are pivotally positionable relative to the central receiver 44. A plurality of paint rollers 50 is coupled to the head 34 and each paint roller 50 of the plurality of paint rollers 50 is aligned on an adjustable rotational axis 52 and is independently rotatable relative to each other. The plurality of paint rollers 50 includes a center roller 54 being coupled to the central receiver 44 of the receiving bracket 42. A first lateral roller 56 is coupled to the first lateral receiver 46 of the receiving bracket 42, wherein the first lateral roller 56 is pivotally positionable relative to the center roller 54. A second lateral roller 58 is pivotally coupled to the second lateral receiver 48 of the receiving bracket 42, wherein the second lateral roller 58 is pivotally positionable relative to the center roller 54.

An actuator 60 is coupled to the handle assembly 12 and is mechanically couplable with the head 34. The actuator 60 is actuated to position the paint rollers 50 from a first position 62 wherein the paint rollers 50 are in alignment with each other to a second position 64 wherein the paint rollers 50 are angled with respect to each other. The first position 62 is defined by a first rotational axis 66 of the first lateral roller 56 and a second rotational axis 68 of the second lateral roller 58 being co-axial to a center rotational axis 70 of the center roller 54. The second position 64 is defined by the first 66 and second 68 rotational axes not being co-axial with each other or with the center rotational axis 70. The first 66 and second 68 rotational axes are typically orthogonal to the center rotational axis 70 when in the second position. The second position 64 is configured for facilitating painting multiple surfaces of a vertical support 65 of a deck 67. The vertical support 65 of the deck 67 typically has four surfaces positioned in a rectangular shape, wherein the second position 64 is capable of applying paint to three of the four surfaces of the vertical support 65 of deck 67.

The actuator 60 may be positionable from an open position 72 to a closed position 74, wherein the open position 72 actuates positioning the receiving bracket 42 into the first position 62 and the closed position actuates positioning the receiving bracket 42 into the second position 64. The actuator 60 may comprise a trigger 76 being mechanically coupled to an actuating arm 78 positioned within the handgrip 14. The actuating arm 78 may be coupled to an extension arm 80 positioned within the elongated member 28. The actuating arm 78 extends the extension arm 80 when the trigger 76 is pulled inwardly towards the handgrip 14. An tip 82 of the extension arm 80 actuates a tension spring 84 positioned within the insert 36 of the head 34 to extend a first lever 86 and a second lever 88. The first lever 86 is coupled to the first lateral receiver 46 of the receiving bracket 42 and the second lever 88 is coupled to the second lateral receiver 48 of the receiving bracket 42. The first 86 and second 88 levers pivotally position the first 46 and second 48 lateral receivers of the receiving bracket 42 into the second position 64 when the tip 82 of the extension arm 80 actuates the tension spring 84. A biasing member 90 may be coupled to the actuator 60 and biases the actuator 60 into the open position 72. The biasing member 90 typically comprises a torsion spring coupled to the back wall 22 and to a back side of the trigger 76. A clasp 92 is coupled to the actuator 60 and releasably fastens the actuator 60 in the closed position 74. The clasp 92 typically comprises a pawl and ratchet mechanism. The pawl 94 is pivotally coupled to the handgrip 14 and the ratchet 96 is coupled to the actuator 60, wherein the pawl 94 mechanically engages with the ratchet 96. The pawl 94 may include a spring-loaded button 98 to releasably secure the pawl 94 from a locking position 100 to an unlocking position 102.

A light emitter 104 is coupled to the handle assembly 12 and emits light when actuated. The light emitter 104 is coupled to the end 30 of the elongated member 28 such that the light emitter 104 emits light towards the plurality of paint rollers 50. The light emitter 104 normally comprises a light emitting diode. A switch 106 is coupled to the handle assembly 12 and is electrically coupled to the light emitter 104. The switch 106 is actuated to power on or off the light emitter 104. The switch 106 is typically mounted on the back wall 22 of the handgrip 14. A power supply 108 is coupled to the handle assembly 12 and is electrically coupled to the light emitter 104 and to the switch 106. The power supply 108 may be mounted to the back wall 22 within the handgrip 14. The power supply 108 may be rechargeable and a charging port 110 may be mounted to the handle assembly 12 and be electrically coupled to the power supply 108.

In use, the head 34 is attached to the handle assembly 12 by inserting the insert 36 of the head 34 into the opening 32 of the elongated member 28. Each paint roller 50 of the plurality of paint rollers 50 typically receives paint prior to abutting each paint roller 50 of the plurality of paint rollers 50 to a surface. The actuator 60 may be actuated to position the paint rollers 50 into the second position 64 to facilitate painting multiple surfaces of the vertical support 65 of the deck 67. The switch 106 may be actuated to emit light from the light emitter 104 onto the surface the paint rollers 50 are applying paint to. The head 34 may be removed from the handle assembly 12 when the user would like to use the plurality of paint rollers 50 without using the handle assembly 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A paint applicator device comprising:
a handle assembly;
a head being removably couplable to said handle assembly;
a plurality of paint rollers being coupled to said head, each paint roller of said plurality of paint rollers being aligned on an adjustable rotational axis and being independently rotatable relative to each other; and
an actuator being coupled to said handle assembly and being mechanically couplable with said head, said actuator being actuated to position said paint rollers from a first position wherein said paint rollers are in alignment with each other to a second position wherein said paint rollers are angled with respect to each other.

2. The paint applicator device of claim 1, wherein said handle assembly includes a handgrip, said handgrip including an exterior wall and enclosing an interior space, said exterior wall including a top wall, a back wall, a bottom wall, and a pair of side walls, said pair of side walls being positioned perpendicular relative to said top and bottom walls.

3. The paint applicator device of claim 2, further including an elongated member being coupled to and extending outwardly from said handgrip, an end of said elongated member having an opening therein, said head including an insert being removably insertable within said opening of said elongated member.

4. The paint applicator device of claim 3, further including a receiving bracket being coupled to said insert, said receiving bracket including a central receiver, a first lateral receiver, and a second lateral receiver, said central receiver being static relative to said first and second lateral receivers, said first lateral receiver being pivotally coupled to a first end of said central receiver, said second lateral receiver being pivotally coupled to a second end of said central receiver, said plurality of paint rollers including a center roller being coupled to said central receiver of said receiving bracket, a first lateral roller being coupled to said first lateral receiver of said receiving bracket, wherein said first lateral roller is pivotally positionable relative to said center roller, a second lateral roller being pivotally coupled to said second lateral receiver of said receiving bracket, wherein said second lateral roller is pivotally positionable relative to said center roller.

5. The paint applicator device of claim 4, wherein said first position defines a first rotational axis of said first lateral roller and a second rotational axis of said second lateral roller are co-axial to a center rotational axis of said center roller, said second position defining said first and second rotational axes not being co-axial with each other or with said center rotational axis.

6. The paint applicator device of claim 5, wherein said first and second rotational axes are orthogonal to said center rotational axis when in said second position.

7. The paint applicator device of claim 5, wherein said actuator is positionable from an open position to a closed position, wherein said open position actuates positioning said receiving bracket into said first position and said closed positioned actuates positioning said receiving bracket into said second position, a biasing member being coupled to said actuator and biasing said actuator into said open position.

8. The paint applicator device of claim 2, wherein said clasp comprises a pawl and ratchet mechanism, said pawl being pivotally coupled to said handgrip and said ratchet being coupled to said actuator, wherein said pawl mechanically engages with said ratchet.

9. The paint applicator device of claim 2, further including a light emitter being coupled to said handle assembly, said light emitter emitting light when actuated, said light emitter being coupled to said end of said elongated member, said light emitter comprising a light emitting diode.

10. The paint applicator device of claim 17, further including a switch being coupled to said handle assembly and being electrically coupled to said light emitter, said switch being actuated to power on or off said light emitter, said switch being mounted on said back wall of said handgrip.

11. The paint applicator device of claim 18, further including a power supply being coupled to said handle assembly and being electrically coupled to said light emitter and to said switch, said power supply being mounted to said back wall within said handgrip, said power supply being rechargeable, a charging port being mounted to said handle assembly and being electrically coupled to said power supply.

12. A paint applicator device comprising:
a handle assembly, said handle assembly including:
a handgrip, said handgrip including an exterior wall and enclosing an interior space, said exterior wall including a top wall, a back wall, a bottom wall, and a pair of side walls, said pair of side walls being positioned perpendicular relative to said top and bottom walls; and
an elongated member being coupled to and extending outwardly from said handgrip, an end of said elongated member having an opening therein;
a head being removably couplable to said handle assembly, said head including an insert being removably insertable within said opening of said elongated member, a receiving bracket being coupled to said insert, said receiving bracket including a central receiver, a first lateral receiver, and a second lateral receiver, said central receiver being static relative to said first and second lateral receivers, said first lateral receiver being pivotally coupled to a first end of said central receiver, said second lateral receiver being pivotally coupled to a second end of said central receiver;
a plurality of paint rollers being coupled to said head, each paint roller of said plurality of paint rollers being aligned on an adjustable rotational axis and being independently rotatable relative to each other, said plurality of paint rollers including:
a center roller being coupled to said central receiver of said receiving bracket;
a first lateral roller being coupled to said first lateral receiver of said receiving bracket, wherein said first lateral roller is pivotally positionable relative to said center roller;
a second lateral roller being pivotally coupled to said second lateral receiver of said receiving bracket, wherein said second lateral roller is pivotally positionable relative to said center roller;
an actuator being coupled to said handle assembly and being mechanically couplable with said head, said actuator being actuated to position said paint rollers from a first position wherein said paint rollers are in alignment with each other to a second position wherein said paint rollers are angled with respect to each other, said first position defining a first rotational axis of said first lateral roller and a second rotational axis of said second lateral roller being co-axial to a center rotational axis of said center roller, said second position defining said first and second rotational axes not being co-axial with each other or with said center rotational axis, said first and second rotational axes being orthogonal to said center rotational axis when in said second position, said actuator is positionable from an open position to a closed position, wherein said open position actuates positioning said receiving bracket into said first position and said closed positioned actuates positioning said receiving bracket into said second position, a biasing member being coupled to said actuator and biasing said actuator into said open position;
a clasp being coupled to said actuator and releasably fastening said actuator in said closed position, said clasp comprising a pawl and ratchet mechanism, said pawl being pivotally coupled to said handgrip and said ratchet being coupled to said actuator, wherein said pawl mechanically engages with said ratchet;
a light emitter being coupled to said handle assembly, said light emitter emitting light when actuated, said light emitter being coupled to said end of said elongated member, said light emitter comprising a light emitting diode;
a switch being coupled to said handle assembly and being electrically coupled to said light emitter, said switch being actuated to power on or off said light emitter, said switch being mounted on said back wall of said handgrip; and
a power supply being coupled to said handle assembly and being electrically coupled to said light emitter and to said switch, said power supply being mounted to said back wall within said handgrip, said power supply being rechargeable, a charging port being mounted to said handle assembly and being electrically coupled to said power supply.
